(19) United States
(12) Patent Application Publication
(10) Pub. No.: US 2020/0056397 A1
(43) Pub. Date: Feb. 20, 2020

(54) ENGINEERED RANCH RAIL FENCING

(71) Applicant: LOUISIANA-PACIFIC CORPORATION, Nashville, TN (US)

(72) Inventor: JARROD KEVIN LINE, BRENTWOOD, TN (US)

(21) Appl. No.: 16/525,314

(22) Filed: Jul. 29, 2019

Related U.S. Application Data
(60) Provisional application No. 62/711,497, filed on Jul. 28, 2018.

(51) Int. Cl. E04H 17/14; B27K 3/36; B27K 3/22

(52) U.S. Cl. CPC E04H 17/1413; E04H 2017/1452; B27K 3/22; B27K 3/36

(57) ABSTRACT

A system for constructing ranch rail fencing with posts and rails from engineered wood products, including, but not limited to, oriented-strand board (OSB), laminated veneer lumber (LVL), fiber strand, and/or laminated strand lumber (LSL). The engineered wood products may be treated and/or encapsulated, such as zinc borate (ZB) treated wood-based composites with high resin content, coated during manufacturing on all surfaces and sides by aliphatic polyurea coatings.

This application claims benefit of and priority to U.S. Provisional App. No. 62/711,497, filed Jul. 28, 2018, which is incorporated herein by specific reference for all purposes.

### FIELD OF INVENTION

This invention relates to a system for an engineered ranch rail fencing comprising engineered wood components.

### SUMMARY OF THE INVENTION

In various exemplary embodiments, the present invention comprises a system for constructing ranch rail fencing with posts and rails from engineered wood products, including, but not limited to, oriented-strand board (OSB), laminated veneer lumber (LVL), fiber strand, and/or laminated strand lumber (LSL). Engineered wood products provide the authentic look and appeal of real wood, but with the durability and workability of treated engineered wood, free of knots, voids and other defects found in natural wood.

Ranch rail fencing is considered to be one of the best traditional fencing styles for use with horses and other ranch animals, but also is increasingly popular with large property housing. Ranch rail fencing comprises a series of posts with rails extending therebetween, either nailed to the posts or extending into or through holes in the posts. Three horizontal rows of rails are common, although a fewer or greater number of rows may be used. Diagonal or angled rails also may be used in places (such as gates).

The main challenge in the marketplace for existing ranch rail fencing options is either maintenance or durability. Wood railing has a relatively low up-front cost but high maintenance costs. Vinyl has been used to attempt to solve the maintenance problems, but suffers from poor impact durability.

The present invention addresses both maintenance and durability problems by using a novel combination of treated and encapsulated engineered wood products. The material will enable ground contact by posts (either below ground or in concrete installation), with mechanically attached rails. With the present invention, an improved fence can be assembled more quickly and cheaply than with any prior art materials, and the fence will be higher quality, with longer life and minimal maintenance (i.e., it will require almost no maintenance for 25 years or more).

In several exemplary embodiments, the posts and/or rails comprise, in whole or in zinc borate (ZB) treated wood-based composites (as described above) with high resin content, which is coated during manufacturing on all surfaces and sides by aliphatic polyurea coatings.

### BRIEF DESCRIPTION OF THE DRAWINGS

FIG. 1 shows a view of an exemplary embodiment of the present invention.

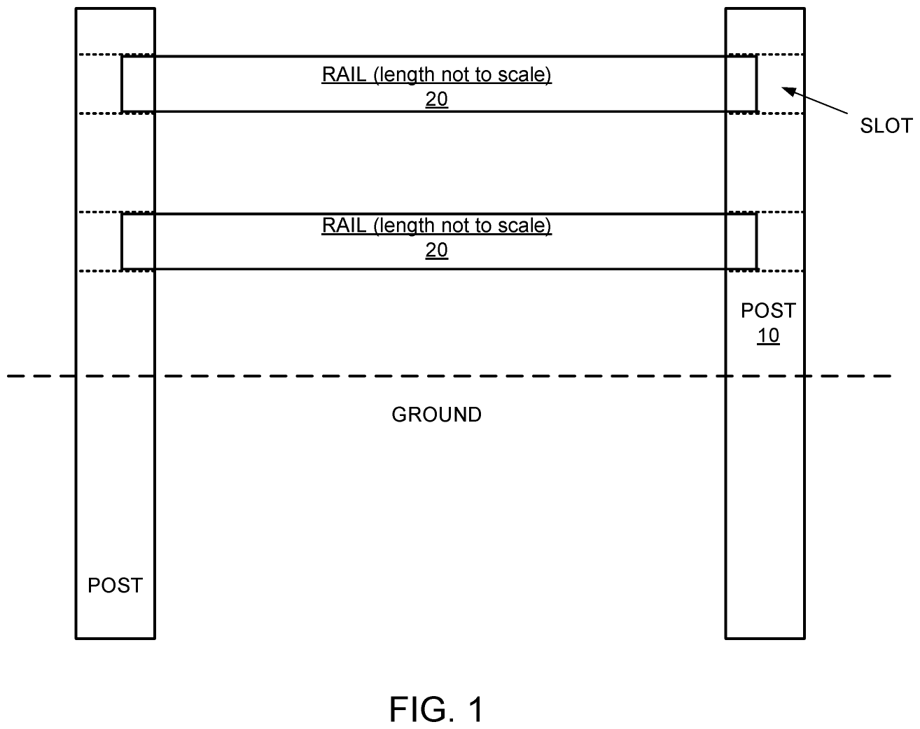

### DETAILED DESCRIPTION OF EXEMPLARY EMBODIMENTS

In various exemplary embodiments, the present invention comprises a system for constructing ranch rail fencing with posts and rails from engineered wood products, including, but not limited to, oriented-strand board (OSB), laminated veneer lumber (LVL), fiber strand, and/or laminated strand lumber (LSL). Engineered wood products provide the authentic look and appeal of real wood, but with the durability and workability of treated engineered wood, free of knots, voids and other defects found in natural wood.

Ranch rail fencing is considered to be one of the best traditional fencing styles for use with horses and other ranch animals, but also is increasingly popular with large property housing. Ranch rail fencing comprises a series of posts with rails extending therebetween, either nailed to the posts or extending into or through holes in the posts. Three horizontal rows of rails are common, although a fewer or greater number of rows may be used. Diagonal or angled rails also may be used in places (such as gates).

The main challenge in the marketplace for existing ranch rail fencing options is either maintenance or durability. Wood railing has a relatively low up-front cost but high maintenance costs. Vinyl has been used to attempt to solve the maintenance problems, but suffers from poor impact durability.

The present invention addresses both maintenance and durability problems by using a novel combination of treated and encapsulated engineered wood products. The material will enable ground contact by posts 10 (either below ground or in concrete installation), with mechanically attached rails 20. With the present invention, an improved fence can be assembled more quickly and cheaply than with any prior art materials, and the fence will be higher quality, with longer life and minimal maintenance (i.e., it will require almost no maintenance for 25 years or more).

In several exemplary embodiments, the posts and/or rails comprise, in whole or in zinc borate (ZB) treated wood-based composites (as described above) with high resin content, which is coated during manufacturing on all surfaces and sides by aliphatic polyurea coatings. These coatings are applied at thicknesses of from approximately 5 mils to approximately 15 mils, and provide high surface durability and UV stability. If encapsulated materials are punctured during use, the ZB preservative and high resin content of the LSL will continue to protect the composite material from decay.

In one exemplary embodiment, posts are manufactured from ZB-treated LSL billets that are 3.5 inches thick. Posts are 3.5″×3.5″ square (or approximately 3.5″ in diameter for cylindrical posts) and from approximately 6 to 16 feet long. Three to five rail slots or holes are milled through cross-sectionally (i.e., through the width of the post), at a dimension of approximately 1.5″ wide and approximately 4-6″ high, depending on the application. Rails are manufactured from ZB-treated rim board, cut into 1⅜″ by 4-6″ rails in lengths up to 8 feet.

The cut ports and rails are then coated/encapsulated by the aliphatic polyurea coatings described above. All exterior surfaces are covered, including the slots cut into the posts. Depending on the coating, curing times range from approximately 3 to 5 minutes. After curing, the products are packaged for delivery.

In several embodiments, some or all of the posts and/or rails may comprise a combination of metal (e.g., steel, aluminum or the like) with the wood-based composite, untreated or treated as described above.

Installation is similar to other wood-based ranch rail systems, with posts installed followed by insertion and affixation of the rails. In some embodiments, traditional puncturing-type fasteners (e.g., nails) would not be recommended, as puncturing the surface will lead to premature decay. In one exemplary embodiment, compatible construction adhesives may be used to re-inforce the mechanical connection between inserted rails and the posts.

Accordingly, the present invention provides an exterior ranch rail fence with enhanced durability, lower maintenance, weather-resistance, fade resistance, and aesthetics at a lower cost and faster installation as compared to prior art fences and materials.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for ranch & rail fencing, comprising:
a plurality of posts comprising engineered wood composite material; and
a plurality of rails comprising engineered wood composite material;
wherein the engineered composite material is treated to resist decay.

2. The system of claim 1, wherein the engineered composite material is treated with zinc borate.

3. The system of claim 1, wherein the engineered composite material has high resin content.

4. The system of claim 1, wherein the engineered composite material is coated or encapsulated.

5. The system of claim 1, wherein the engineered composite material is coated or encapsulated with an aliphatic polyuria coating.

6. The system of claim 1, wherein the rails are attached to said posts by a non-penetrating mechanical fastener.
